(19) United States
(12) Patent Application Publication
(10) Pub. No.: US 2009/0051488 A1
(43) Pub. Date: Feb. 26, 2009

(54) COMMUNICATION SYSTEM HAVING TRANSMITTER AND RECEIVER AND SIGNAL SENDING/RECEIVING METHOD

(75) Inventors: Tsutomu Murata, Kasugai-shi (JP); Masaki Fujii, Kasugai-city (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (US)

(21) Appl. No.: 12/193,891

(22) Filed: Aug. 19, 2008

(30) Foreign Application Priority Data
Aug. 22, 2007 (JP) 2007-215957

(51) Int. Cl. B60R 25/00

(52) U.S. Cl. 340/5.72

(57) ABSTRACT

A technique for achieving a risk-free keyless entry system for vehicles at low costs is disclosed. The keyless entry system includes a transmitter responsive to an operation of an operation unit for transmitting a signal indicative of to-be-sent information toward an on-board device at a prespecified communication rate. The on-board device is attached to inside of a vehicle, for receiving electrical waves as sent from the transmitter and for outputting a control signal used to drive electric motors of door lock actuators and/or a motor of slide door actuator. By changing the communication rate of the signal being sent from the transmitter, the door lock control signal is made shorter in arrival distance than the slide door control signal.

### BACKGROUND OF THE INVENTION

1. Field of the Invention

The present invention relates to communication systems including a transmitter and receiver and also to signal sending/receiving methodology. More particularly, but not exclusively, this invention relates to a communication system capable of achieving a safe keyless entry system at low costs, a transmitter and receiver for use therein, and a signal sending/receiving method.

2. Description of Related Art

In recent years, the so-called keyless entry system has been practically implemented as an entry system for vehicles or automobiles. The keyless entry system may typically be configured to include a radio transmitter owned by a user, such as a car driver, and a receiver which is attached to his or her car.

The keyless entry system is, for example, a system which operates, when the user depresses one or more switches of the transmitter, to output a signal in accordance with a combination of the pushed switches and then perform locking and unlocking of car doors in an event that a built-in processor of a receiver recognizes the information that is demodulated by a signal reception circuit of the receiver as a proper signal. Recently, the keyless entry system is becoming more widely used in applications for control of the car's trunk, headlights and others.

Unlike the doors, the headlights are desirably capable of being operated at land locations far from the car 110. To meet this need, a technique is proposed (for example, see JP-A-63-141151) for enabling changeover of signal transmission intensity in the event that a signal is sent over-the-air from a radio transmitter. Another technique is also proposed (e.g., in JP-A-10-166966) for switching the duty ratio of a signal from the transmitter.

Incidentally, in the keyless entry system, when the user attempts to manually operate the switch(es) of his or her transmitter at a location within an area in which signals of the transmitter are reached, a receiver that is attached to the user's vehicle performs adequate processing in accordance with the information of a demodulated signal. No problems occur as far as every signal being issued from the transmitter is based on the user's intended operation. However, in case the transmitter is held in a pocket or a bag, something can collide with a transmitter switch(es), resulting in the user's unintentional signal being output from time to time.

For example, no doors are operated if it is the processing for performing a door locking or unlocking operation. However, in the case of processing for releasing either a trunk opener or a motor-driven door, the trunk or the door is actually actuated to move. Thus, an operation error would lead to accidental occurrence of danger and/or car theft.

In view of this, one conceived approach is to limit the arrival distance of electromagnetic wave signals only to nearby locations of the automobile of interest, thereby allowing the user to readily become aware of the fact that the processing due to the receiver was actually performed. An example of the electromagnetic wave signal arrival distance control technique is a method of performing control of output power on the signal transmission side. Another example is a technique for performing comparison of electric field intensity with a reference level on the signal reception side. Unfortunately, advantages of the known techniques do not come without accompanying a penalty which follows: additional use of control/measurement circuits and components are needed, resulting in unwanted cost increases.

### SUMMARY OF THE INVENTION

This invention has been made in view of the above-stated technical background, and its object is to provide a technique for enabling achievement of a security-enhanced keyless entry system at low costs.

In accordance with one aspect of this invention, a communication system is provided, which has a transmitter capable of being carried by a user and a receiver equipped in a vehicle for receiving a signal as sent from the transmitter and for controlling a plurality of devices also equipped in the vehicle while letting one of them correspond to the signal received. The transmitter includes an operation specifying unit for specifying that an operation of the user corresponds to which one of operations of the plurality of devices, a data generation unit for generating an information item corresponding to the specified operation and being selected from a plurality of prestored information items as a digital data at a communication rate being set to any one of at least first and second communication rates of a plurality of communication rates defined correspondingly to the information item, a modulation unit for modulating a signal of the data generated by the data generation unit, and a transmission unit for wirelessly sending a signal modulated. The receiver includes a demodulation unit for receiving the signal sent from the transmitter and for demodulating the signal into the digital data, a filter having an attenuation amount defined in a way corresponding to a communication rate of the data demodulated by the demodulation unit, for attenuating data of the second communication rate more significantly than data of the first communication rate, a comparison unit for comparing a voltage level of the data that passed through the filter with a threshold value, and a control unit responsive to receipt of data being determined to have a voltage level greater than or equal to the threshold value by comparison of the comparator unit, for outputting a control signal for control of one of the devices equipped in the vehicle.

In the communication system of this invention, the transmitter operates to specify that an operation of the user corresponds to which one of operations of the plurality of devices. Then, an information item which corresponds to the specified operation and which is selected from a plurality of prestored information items is generated in a form of digital data at a communication rate that is set to any one of at least first and second communication rates of a plurality of communication rates defined correspondingly to the information item. The data generated is modulated to provide a modulated signal, which is sent wirelessly. The signal as sent from the transmitter is received by the receiver and is then demodulated. The filter having its attenuation amount defined in a way corresponding to a communication rate of the demodulated data is rendered operative to attenuate data of the second communication rate more significantly than data of the first communication rate. The voltage level of the data that passed through the filter is compared with a threshold value. Upon receipt of data being determined to have a voltage level greater than or equal to the threshold value by the comparison, a control signal is output, which is for control of any one of the devices equipped in the vehicle.

Thus, it is possible to adequately set the signal's arrival distance in accordance with the operation.

In accordance with another aspect of this invention, a transmitter carriable by a user and adaptable for use in a communication system is provided. The communication system includes the transmitter and a receiver equipped in a vehicle for receiving a signal sent from the transmitter and for controlling a plurality of devices also equipped in the vehicle in a way corresponding to the received signal. The transmitter is generally made up of an operation specifying unit for specifying that an operation of the user corresponds to which one of operations of the plurality of devices, a data generation unit for generating an information item corresponding to the specified operation and being selected from a plurality of prestored information items in a form of digital data at a communication rate being set to any one of at least first and second communication rates of a plurality of communication rates defined correspondingly to the information item, a modulation unit for modulating a signal of the data generated by the data generation unit, and a transmission unit for wirelessly sending the signal modulated.

The data of the first communication rate may typically be usable as data concerning control of door lock of the vehicle whereas the data of the second communication rate is for use as data concerning control of a slide door of the vehicle.

Thus it is possible to make the land-vehicle slide-door control signal shorter in arrival distance than the vehicle door-lock control signal.

In accordance with a still another aspect of the invention, a signal transmission method of a transmitter for use in a communication system is provided. The transmitter is carriable by a user. The communication system has this transmitter and a receiver equipped in a vehicle for receiving a signal sent from the transmitter and for controlling a plurality of devices also equipped in the vehicle in a way corresponding to the received signal. The signal transmission method includes the steps of specifying that an operation of the user corresponds to which one of operations of the plurality of devices, generating an information item being selected from a plurality of prestored information items and corresponding to the specified operation as digital data at a communication rate being set to any one of at least first and second communication rates of a plurality of communication rates defined correspondingly to the information item, modulating a signal of the data generated, and wirelessly sending a signal modulated.

In the transmitter and the signal transmission method of this invention, an attempt is made to specify that an operation of the user corresponds to which one of operations of the plurality of devices. Then, an information item which is selected from a plurality of prestored information items and which corresponds to the specified operation is generated as digital data at a communication rate being set to any one of at least first and second communication rates of a plurality of communication rates defined correspondingly to the information item. A signal of the data generated is modulated, and the modulated signal is then sent over-the-air wirelessly.

In accordance with a further aspect of the invention, a receiver for use in a communication system having a transmitter capable of being carried by a user is provided. The receiver is equipped in a vehicle for receiving a signal sent from the transmitter and for controlling a plurality of devices also equipped in the vehicle in a way corresponding to the received signal. The receiver includes a demodulation unit for receiving the signal sent from the transmitter and for demodulating the signal into the data, a filter having its attenuation amount defined in a way corresponding to a communication rate of the data demodulated by the demodulation unit, for attenuating data of the second communication rate more significantly than data of the first communication rate, a comparison unit for comparing a voltage level of the data that passed through the filter with a threshold value, and a control unit responsive to receipt of data being determined to have a voltage level greater than or equal to the threshold value by comparison of the comparison unit for outputting a control signal for control of one of the devices equipped in the vehicle.

The control unit may be configured to output a control signal relating to door lock control of the vehicle when the data of the first communication rate is supplied thereto and output a control signal relating to slide door control of the vehicle when the data of the second communication rate is supplied thereto.

Thus it is possible to make the land-vehicle slide-door control signal shorter in arrival distance than the vehicle door-lock control signal.

In accordance with another further aspect of the invention, a signal receiving method of a receiver for use in a communication system having a transmitter capable of being carried by a user is provided. The receiver is equipped in a vehicle for receiving a signal sent from the transmitter and for controlling a plurality of devices also equipped in the vehicle in a way corresponding to the received signal. The signal receiving method includes the steps of receiving a signal as sent from the transmitter for demodulating the signal into the data, causing a filter having its attenuation amount defined by a communication rate of the demodulated data to attenuate data of the second communication rate more significantly than data of the first communication rate, comparing a voltage level of the data which passed through the filter to a threshold value, and outputting, when receiving data having its voltage level as determined by the comparison to be greater than or equal to the threshold value, a control signal for control of one of the devices equipped in the vehicle.

In the receiver and the signal receiving method of this invention, when receiving a signal as sent from the transmitter for demodulating the signal into the data, this signal is demodulated. By the filter having its attenuation amount defined by a communication rate of the demodulated data, data of the second communication rate is attenuated more significantly than data of the first communication rate. The voltage level of the data that passed through the filter is compared to a threshold value. Upon receipt of data having its voltage level as determined by the comparison to be greater than or equal to the threshold value, a control signal is output, which is for control of one of the devices equipped in the vehicle.

According to this invention, it is possible to provide the security-increased low-cost keyless entry system.

### BRIEF DESCRIPTION OF THE DRAWINGS

FIG. 1 is a block diagram showing a configuration example of a communication system in accordance with one embodiment of this invention.

FIG. 2 is a block diagram showing a configuration example of a transmitter shown in FIG. 1.

FIGS. 3A and 3B are diagrams for explanation of examples of signals to be generated from the transmitter.

FIG. 4 is a diagram for explanation of an exemplary signal as generated by the transmitter.

FIGS. 5A and 5B are diagrams for explanation of exemplary signals generated by the transmitter.

FIG. 6 is a block diagram showing an exemplary configuration of an on-board device of FIG. 1.

FIG. 7 is a graph showing typical filter characteristics of a filter unit.

FIGS. 8A to 8E are diagrams for explanation of exemplary signals to be processed by the on-board device.

FIGS. 9A to 9E are diagrams for explanation of exemplary signals to be processed by the on-board device.

FIG. 10 is a flow chart for explanation of signal transmission processing.

FIG. 11 is a flowchart for explanation of signal receiving processing.

FIG. 12 is a block diagram showing a configuration example of a personal computer (PC).

### DETAILED DESCRIPTION OF THE INVENTION

A currently preferred embodiment of this invention will be described with reference to the accompanying figures of the drawing below.

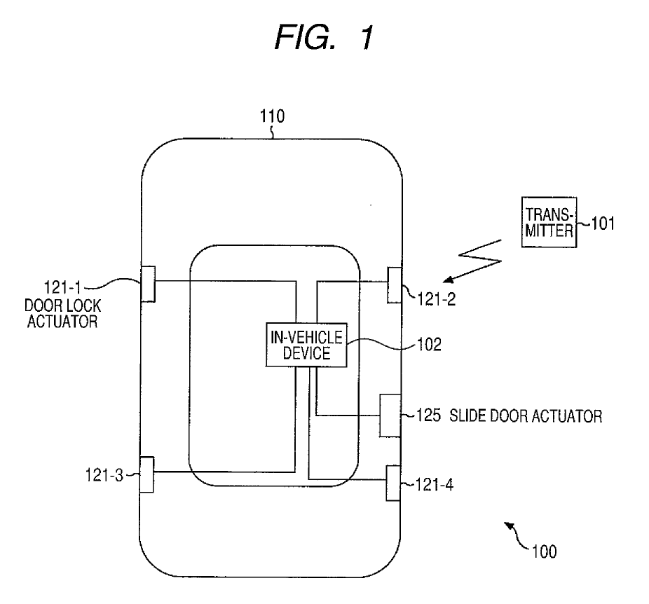

FIG. 1 is a block diagram showing a configuration example of a communication system 100 in accordance with one embodiment of this invention. This communication system 100 is configured to include a transmitter and a receiver. The communication system 100 is configured, for example, as a keyless entry system for vehicles. The transmitter is of the portable or “mobile” type capable of being carried by a user. The receiver is configured as on-board equipment which is attached to vehicles, such as an automobile. In the example as depicted herein, the communication system 100 is made up of a transmitter 101 and an on-board device 102 attached to a car 110.

The transmitter 101 is configured to have on its top panel a push button-type manual operation unit. This operation unit has a plurality of switches as will be described in detail later. The transmitter 101 has a built-in battery unit. This transmitter is operative to send over-the-air a signal indicative of the information to be transmitted to the on-board device 102 in a way corresponding to an operation of the operation unit.

The on-board device 102 is attachable to inside of the car 110, for enabling reception of electric waves as sent from the transmitter 101 via an antenna. Typically, this device 102 is attached to a door of the car 110 or its nearby portions.

The on-board device 102 is electrically connected by control signal transmission wires or the like to door lock actuators 121-1 to 121-4 which drive electrical motors of a mechanism for locking/unlocking of car doors or to a slide door actuator 125 which drives an electric motor that is driven to open a slide door of the car 110, for outputting a control signal(s) to the motors of door lock actuators 121-1 to 121-4 or the motor of slide door actuator 125 in response to receipt of an electric wave sent from the transmitter 101.

It should be noted that the signal as sent from the transmitter 101 to be received by the on-board device 102 changes in intensity with a change in distance between the on-board device 102 and transmitter 101. In other words, the smaller the distance between transmitter 101 and on-board device 102, the greater the intensity of a signal received; the more the distance between transmitter 101 and on-board device 102, the less the intensity of the signal received. It is thus assumed that a limit of the distance (communicable range) which enables the transmitter 101 and on-board device 102 to communicate with each other is predefined.

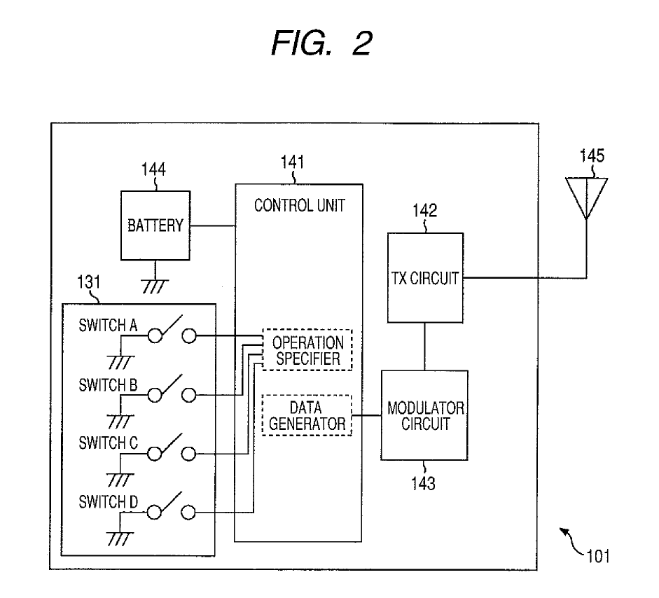

FIG. 2 is a block diagram showing a configuration example of the transmitter 101. As previously stated, the transmitter 101 is provided, on its external side, with the operation unit 131 having switches A to D as manually operated by a user, such as a car driver.

For example, the switch “A” is designed as a switch for instruction of the locking of a door (door lock). The switch B is a switch for unlocking the door (door unlock). The switch C is a slide door open switch. The switch D is a slide door close switch.

A control unit 141 is generally made up of a microcomputer and an input/output (I/O) interface or else. A software program to be installed in the microcomputer constituting the control unit 141 is typically designed to have functional modules including, but not limited to, an operation specifying unit and a data generation unit.

For example, when the user depresses the switch A, the program in the microcomputer of control unit 141 is executed, causing the operation specifier to read as an input a present contact state of the switch A and specify that the switch A was operated, while at the same time causing the data generator to generate binarized digital data indicative of certain information corresponding to the switch A and then pass the output digital data to a modulation circuit 143. This information corresponding to the switch A is prestored in an internal memory or else of the microcomputer, with other information items corresponding to the switches B to D also being prestored in such microcomputer memory.

The digital data obtained by binarization of prespecified information corresponding to any one of the switches A to D involves a preamble, an identification (ID) code unique to the transmitter 101, a rolling code used for encryption and others.

The binary digital data of prespecified information corresponding to any one of the switches A-D has a per-switch different part, called the function code. For example, setting is done so that a function code with its logical value “0101” means an instruction to lock a car door.

The modulator circuit 143 applies amplitude shift keying (ASK) modulation with such digital data being as a base-band signal.

This modulated signal is sent forth to a transmission circuit 142 for radio-transmission via an antenna 145.

The control unit 141, the modulator circuit 143 and the transmitter circuit 142 are configured to have an ability to send a signal(s) at any one of a plurality of kinds of communication speeds or rates. In the transmitter 101, communication speeds (baud rates) corresponding to the switches A-D are preset therein—for example, a data communication rate f1 corresponding to the switches A-B is set to 2 kilobits per second (Kbps). A data communication rate f2 corresponding to the switches C-D is set to 4 Kbps.

The communication rate of digital data to be generated by the control unit 141 and the communication rate of a signal being sent by the modulator circuit 143 and the transmitter circuit 142 may be configured to be selected by the software program of the microcomputer of control unit 141 or, alternatively, may be selected by a certain type of hardware component.

As previously stated, when either the switch A or the switch B is operated by the user, the transmitter 101 sends a corresponding signal at the communication rate f1. When the switch C or the switch D is operated, the transmitter 101 sends a signal at the communication rate f2.

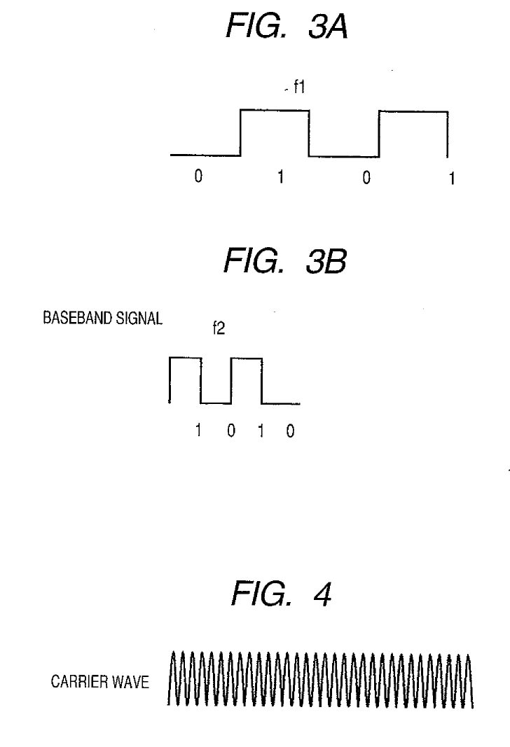

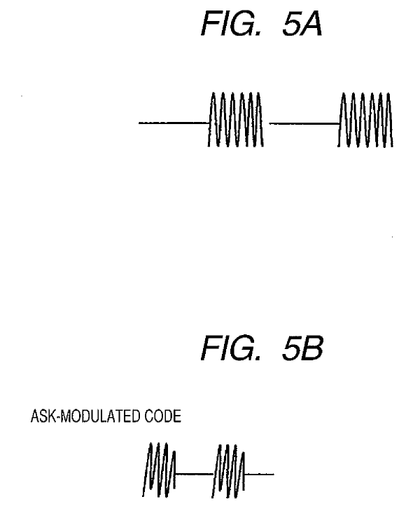

More specifically, when the switch A is operated, the control unit 141 generates a baseband signal (digital data) having a waveform shown in FIG. 5A. When the switch C is operated, the control unit 141 issues a baseband signal (digital data) having a waveform shown in FIG. 3B.

In the case of this example, the signal shown in FIG. 3A is digital data with its communication rate of 2 Kbps; so, it becomes a pulse signal with a frequency of 2 KHz. Regarding the signal of FIG. 3B, this is digital data with its communication rate of 4 Kbps; so, it becomes a pulse signal with a frequency of 4 KHz.

Then, the modulator circuit 143 applies ASK modulation to the baseband signal shown in FIG. 3A or 3B by using a carrier wave shown in FIG. 4.

As a result, when the switch A is operated, the transmitter 101 sends an ASK-modulated signal with its baud rate of 2 Kbps as shown in FIG. 5A. Alternatively, when the switch C is operated, transmitter 101 sends an ASK-modulated signal with its baud rate of 4 Kbps as shown in FIG. 5B.

Although one specific case of using ASK modulation as the modulation technique in this embodiment is discussed here, other modulation methods may alternatively be employed, such as frequency shift keying (FSK), phase shift keying (PSK), or other known shift keying techniques.

It is noted that although one specific example is described which generates the baseband signal in the form of a binarized pulse signal with its data level changing between a logic “0” and logic “1” for purposes of brevity of the explanation herein, the baseband signal may alternatively be generated based on other data systems, such as Manchester coding techniques, for example.

Also note that the switches of the transmitter 101 are not necessarily provided in such a way that one switch is provided per individual control object; for example, one switch may be designed to correspond to two different control objects. More specifically, a switch may be designed to permit a door unlock control signal to be transmitted when this switch is shortly depressed and, when pushed for an increased length of time period that is longer than a predetermined time, allow transmission of a slide door open signal.

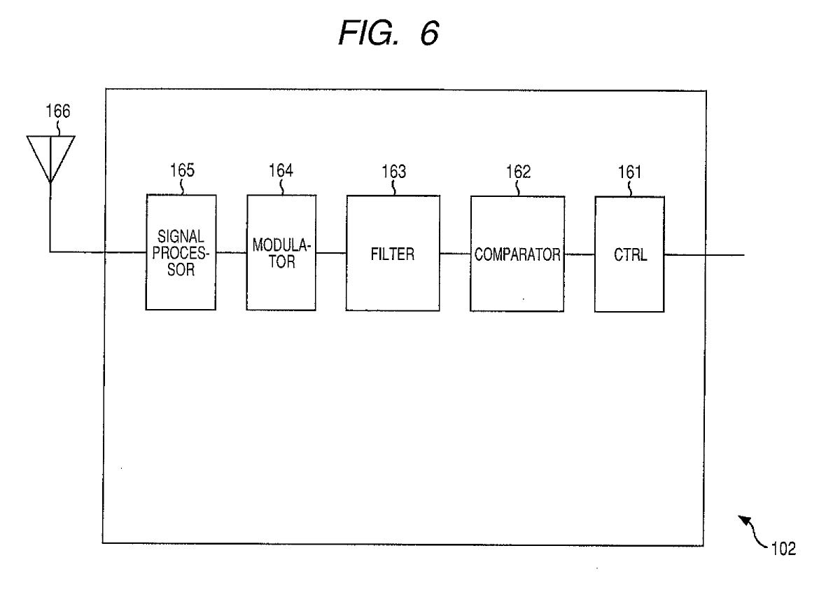

FIG. 6 is a block diagram showing a configuration example of the on-board device 102 of FIG. 1.

The signal that is sent over-the-air from the transmitter 101 is received by an antenna 166 and passed to a signal processing unit 165. This unit amplifies the received signal and converts the carrier wave into an intermediate frequency (IF) signal by mixture with a signal from a local oscillator (not shown); then, the converted signal is supplied to a demodulation unit 164. In brief, the received signal is processed by use of the so-called superheterodyne method.

The resultant signal that was converted by the signal processor unit 165 into the IF signal is subjected at the demodulator unit 164 to envelop detection for demodulation to a baseband signal. This demodulated baseband signal becomes identical to the digital data as output from the control unit 141 of the transmitter 101, for example.

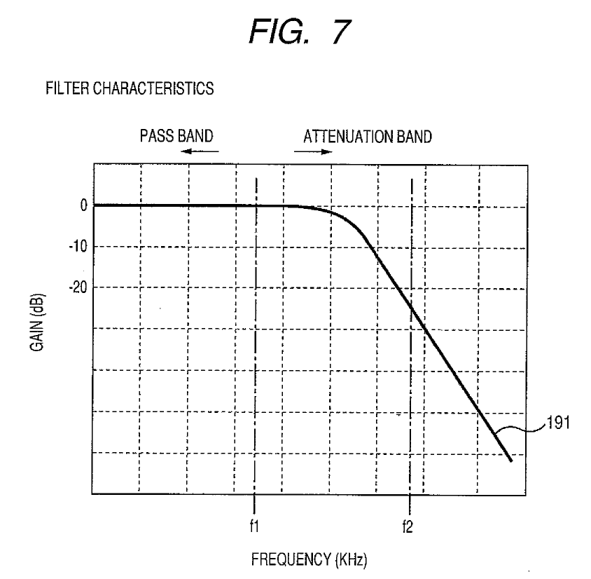

The data demodulated by the demodulator unit 164 is supplied to a filter unit 163. This filter unit 163 is configured to have its filtering characteristics indicated by a solid curve in FIG. 7, for reducing the gain of a signal with a prespecified frequency. In the graph of FIG. 7, its vertical axis denotes the gain whereas the lateral axis indicates the frequency, wherein the filtering characteristic curve of the filter unit 163 is indicated by line 191.

As shown in FIG. 7, when a signal with its frequency being higher in value than the frequency f1 passes through the filter unit 163, its gain is lowered, resulting in the signal being attenuated. On the contrary, when a signal with its frequency lower in value than the frequency f1 passes through the filter unit 163, its gain is kept unchanged, resulting in the signal being not attenuated. In other words, any signal passing through the filter unit 163 is designed to change in attenuation amount in accordance with the frequency of such signal.

In case the frequency (communication rate) of a signal as sent from the transmitter 101 is f1, the frequency of data demodulated by the demodulator unit 164 also becomes equal to f1. This can be said because the baseband signal prior to modulation is a 2-KHz pulse signal in case the ASK-modulated signal that is sent from the transmitter 101 is 2 Kbps in baud rate (communication rate) as previously stated with reference to FIGS. 3A to 5. Accordingly, upon receipt of a signal corresponding to the operation of either the switch A or the switch B of the transmitter 101, the data signal that is demodulated by the demodulator unit 164 is not attenuated in any way even after having passed through the filter unit 163.

Alternatively, in case the frequency (communication rate) of a signal as sent from the transmitter 101 is f2, the frequency of the data demodulated by the demodulator unit 164 also becomes equal to f2. This is true because the baseband signal prior to modulation is a 4-KHz pulse signal in case the ASK-modulated signal that is sent from the transmitter 101 is 4 Kbps in baud rate (communication rate) as stated previously with reference to FIGS. 3A to 5. Therefore, upon receipt of a signal corresponding to the operation of either the switch C or the switch D of the transmitter 101, the data signal that is demodulated by the demodulator unit 164 is attenuated after having passed through the filter unit 163.

Although in the example shown in FIG. 7 the explanation was given by exemplifying one specific case where the filter unit 163 is configured from the so-called low-pass filter (LPF), the filter unit 163 may alternatively be configured by a band-pass filter (BPF) or a high-pass filter (HPF) as far as this is a filter capable of setting so that the signal attenuation amount at the frequency f2 is greater than the attenuation amount at frequency f1.

Alternatively, the filter unit 163 may be configured to have a plurality of filters. In this case, for example, a couple of filters may be arrayed in series to thereby provide a difference between the attenuation amount at the frequency f1 and the attenuation at frequency f2 based on a total sum of an attenuation amount at the first stage and an attenuation amount at the second stage.

Turning back to FIG. 6, the data signal that passed through the filter unit 163 is supplied to a comparator 162. This comparator 162 compares with a predetermined threshold value the voltage potential level of the data as supplied from the filter unit 163. If the voltage level of data is greater than or equal to the threshold value, then output such data to the control unit 141. If the data voltage level is less than the threshold then output such data to a control unit 161 as either an all-“0” signal or a null signal.

The control unit 161 is configured to have a microcomputer or else. Upon input of data to the control unit 161, this unit performs checking of ID code and function code which are contained in the input data with the data being prestored in a memory of the microcomputer. When the function code contained in the data as input from the comparator 162 is identical to any one of the stored data (i.e., data indicative of a plurality of function codes), the control unit 161 executes specified control in accordance with such function code.

For example, when the control unit 161 determines that the function code is data “0101” indicating door locking, the on-board device 102 generates a control signal for driving the door lock actuators 121-1 to 121-4. In responding thereto, the door lock actuators 121-1 to 121-4 drive their associated motors or else to lock the car doors.

In this invention, an arrangement is employed for causing the distance for enabling the on-board device 102 to operate (i.e., distance between the on-board device 102 and the transmitter 101) to become different based on the signal as sent from the transmitter 101 in accordance with a switch being operated by the user, e.g., car driver.

Here, a detailed explanation will be given of operations of the filter unit 163 and the comparator 162.

An explanation will first be given of an exemplary case where the communication rate of a signal sent from the transmitter 101 is f1 (=2 Kbps).

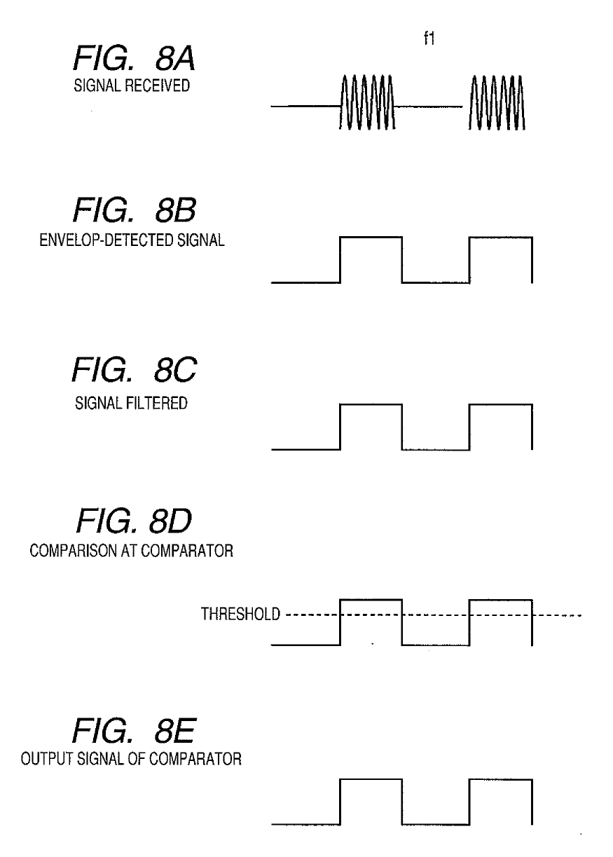

As far as the distance between the transmitter 101 and on-board device 102 is within a preset communicable range (e.g., about 10 meters), a signal shown in FIG. 5A is received by the antenna 166 of the on-board device 102 so that an envelop-detected data signal of 2 Kbps shown in FIG. 8B—i.e., pulse signal with its frequency of 2 KHz—is sent to the comparator 162 without experiencing attenuation at the filter unit 163 as shown in FIG. 8C. This is owing to the fact that the data of communication rate (frequency) f1 is not attenuated by the filtering characteristics of the filter unit 163 as stated previously with reference to FIG. 7. In this case, as shown in FIG. 8D, the data supplied to the comparator 162 has a voltage level which is greater than or equal to the threshold level as indicated by dotted line in FIG. 8D, allowing data shown in FIG. 8E to be supplied to the control unit 161.

On the other hand, in case the distance between the transmitter 101 and on-board device 102 is in excess of the preset communicable range (e.g., about 10 m), the intensity of a signal has already been small at a time point that this signal is received by the on-board device 102 so that this is determined at the comparator 162 to be a voltage level less than the threshold value in spite of the fact that the signal is not attenuated by the filter unit 163 after completion of the envelop detection/demodulation. For this reason, the data being supplied to the control unit 161 is in the state of all “0”s. This means that the data sent from the transmitter 101 is not detectable by the on-board device 102 in any way.

Accordingly, in case the transmitter 101 sends the signal of the communication rate f1, that is, when either the switch A or the switch B is manually operated by the user, if the distance between the transmitter 101 and on-board device 102 falls within the preset communicable range then it becomes possible to render the on-board device 102 operative in response to receipt of the signal sent from the transmitter 101.

Next, an explanation will be given of another exemplary case where the communication rate of the signal sent from the transmitter 101 is f2=4 Kbps.

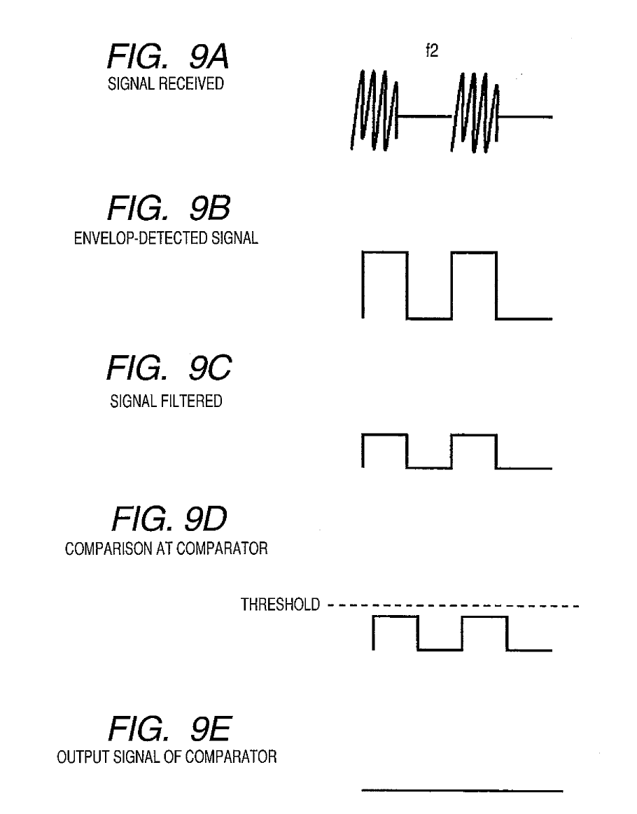

In the case of the communication rate f2=4 Kbps, a signal with its waveform shown in FIG. 9A is received by the antenna 166 of the on-board device 102, causing a 4 Kbps data signal which was envelop-detected at the on-board device 102, as shown in FIG. 9B i.e., 4 KHz pulse signal, to be sent to the comparator 162 after having been attenuated by the filter unit 163 as shown in FIG. 9C. More precisely, the pulse signal shown in FIG. 9C is smaller in amplitude than the pulse signal shown in FIG. 9B; additionally, the former is lower in voltage level than the latter. This can be said because the data of the communication rate (frequency) f2 is forced to attenuate by the filtering characteristics of the filter unit 163 as stated supra with reference to FIG. 7.

Consequently, if the intensity of the signal received by the antenna 166 of on-board device 102 is not significant sufficiently, the voltage level of the data supplied to the comparator 162 becomes less than the threshold level as indicated by dotted line in FIG. 9D. An example is that if the distance between the transmitter 101 and on-board device 102 is about 10 m, the intensity of the signal received by the antenna 166 of on-board device 102 is not so large in spite of the fact that it falls within the inherent communicable range. Thus, the voltage level of the data supplied to the comparator 162 becomes less than the threshold unintentionally so that the data being fed to the control unit 161 is set in the all-“0” state as shown in FIG. 9E.

In the case of the communication rate f2, if the transmitter 101 and on-board device 102 are sufficiently near in distance therebetween, the data that was envelop-detected by the on-board device 102 is attenuated by the filter unit 163 so that its voltage level becomes smaller; however, the resulting voltage level is determined by the comparator 162 to be more than or equal to the threshold level because of the fact that the signal received by the antenna 166 is sufficiently large in intensity. Therefore, the data that was supplied to the comparator 162 via the filter unit 163 is output to the control unit 161 also.

Thus, in the case of the communication rate f2, a specific communicable range is virtually set, which is less than the communicable range in the case of the communication rate f1. This communicable range in the case of the communication rate f2 will be referred to as “virtual communicable range” hereinafter. Assume here that this virtual communicable range is set at about 1 m as an example.

As previously stated, the control unit 161 performs checking of a function code being contained in the supplied data with the data being prestored in the memory or else and then outputs a prespecified control signal in accordance with the function code of the data. An example is that when the function code contained in the supplied data is determined by the control unit 161 to be a function code “1010” which means a slide door opening action, a control signal is output for driving the slide door actuator 125. Whereby, the slide door actuator 125 drives its associative motor, resulting in the slide door of car 110 being opened.

On the contrary, if the distance between the transmitter 101 and on-board device 102 exceeds the setup virtual communicable range (about 1 m), the signal received by the antenna 166 becomes smaller in intensity, causing the data envelop-detected by the on-board device 102 to attenuate at the filter unit 163, resulting in its voltage level becoming further smaller. Thus, it is no longer determined by the comparator 162 that the voltage level is greater than or equal to the threshold. For this reason, the data that was supplied to comparator 162 through filter unit 163 is not output to the control unit 161. This is equivalent to an event that no signal from the transmitter 101 has been received by the on-board device 102.

Now, suppose that the distance between the transmitter 101 and on-board device 102 is midway between the virtual communicable range (about 1 m) and the “real” communicable range (about 10 m)—for example, 5 m.

If this is the case, when the user pushes the switch C for example, data of the communication rate f2 which contains therein a function code “1010” is ASK-modulated and is then transmitted from the transmitter 101. Then, the on-board device 102 receives this sent signal at an intensity which is weaker than that obtained when the distance between the transmitter 101 and on-board device 102 is within the virtual communicable range (about 1 m). Due to this, the resulting envelop-detected data signal is attenuated at the filter unit 163 and determined by the comparator 162 to be less than the threshold level, resulting in no data being supplied to the control unit 161. Thus, no slide doors of the car 110 are driven to open.

Another example is as follows. When the user pushes the switch A, data of the communication rate f1 containing a function code “0101” is ASK-modulated and sent from the transmitter 101. While the on-board device 102 receives this sent signal, it is determined by the comparator 162 to be greater than or equal to the threshold since the envelop-detected data is not attenuated at the filter unit 163, causing the data to be supplied to the control unit 161. As a result, the car 110's doors are locked.

Accordingly, it is no longer possible for the driver who is at a distance of 5 m from the car 110 to open the slide door by pushing the switch C, although he or she is able to lock the car doors by pushing the switch A, for example. To open the slide door, it is a must for the driver to walk to a location at a distance of 1 m or less from his or her car 110 and then push the switch C.

With this arrangement, in order to open and close the slide door, the driver is required to operate the switch at a land location with a specific distance (e.g., 1 m or less) at which she/he visually recognizes a present situation of the car; thus, the safety and/or security becomes higher. In addition, when the switch C or D is pushed by mistake at a far distance, the slide door does not open; so, the security is enhanced.

For instance, when the transmitter 101 is held in a pocket or a bag, something can collide with its switch(es), resulting in the user's unintentional signal(s) being output from time to time.

For example, if it is the processing for locking or unlocking the car doors, no doors move erroneously; however, in the case of the processing for opening the slide door, this slide door actually moves. This operation error can lead to unwanted occurrence of danger and/or theft.

According to this invention, it is possible to limit the arrival distance of a slide door open/close signal only to nearby land locations of the car 110. This makes it possible to facilitate the user or driver to readily become aware of the fact that the slide door opening (or closing) processing was actually performed by the on-board device 102. Thus it is possible to enhance the security of the keyless entry system.

Although in this embodiment one specific example is described for limiting the signal arrival distance to only nearby locations of the car in the case of the slide door being opened/closed, it is also permissible to limit the signal arrival distance only to car nearby locations in the case of unlocking a trunk or opening/closing a hatchback door also.

In this invention, it is also possible to control the switching between the communication rate f1 and the communication rate f2 by the software program as installed in the microcomputer of the transmitter 101 without having to employ any special hardware components, thereby enabling achievement of downsizing of the system at low costs. Additionally, as the on-board device 102 also is capable of extracting both a signal of the communication rate f1 and a signal of the communication rate f2 by use of the same filter, any extra hardware parts are required; thus, it is also possible to achieve system downsizing at low costs.

Note here that in the on-board device 102, a filter that is used to remove noises from a received signal is employable as the filter of the filter unit 163. By doing so, it is possible to achieve further downsizing and cost reduction.

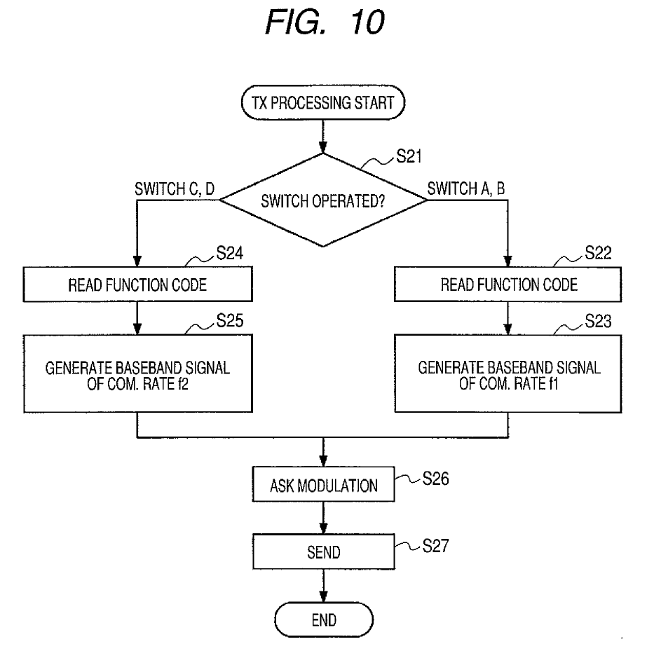

An explanation will next be given of a signal transmission procedure of the transmitter 101 with reference to a flow chart of FIG. 10. This processing is executed when the user manually operates a switch of the operation unit 131 of transmitter 101.

At step S21 of FIG. 10, the control unit 141 determines which one of the switches was manually operated by the user, and advances the processing in a way corresponding to such switch operated.

At step S21, when it is determined that either the switch A or the switch B was operated, the procedure goes to step S22.

At step S22, the control unit 141 reads a function code corresponding to the switch A or switch B, which code is prestored in the memory or else of the microcomputer, for example.

At step S23, the control unit 141 generates, as a baseband signal of the communication rate f1 (frequency f1), digital data containing therein the function code as read out at the process of step S22 along with a preamble and ID code unique to the transmitter plus rolling code(s) for encryption.

If at the step S21 it is determined that either the switch C or switch D was operated, then the procedure goes to step S24.

At step S24, the control unit 141 reads a function code corresponding to the switch C or switch D, which code is prestored in the memory or else of the microcomputer, for example.

At step S25, the control unit 141 generates, as a baseband signal of the communication rate f2 (frequency f2), digital data containing therein the function code as read out at the process of step S24 along with a preamble and ID code unique to the transmitter plus rolling code(s) for encryption.

At step S26, the modulator circuit 143 applies ASK modulation to the baseband signal that was generated by the processing at the step S23 or step S25.

At step S27, the transmitter circuit 142 sends over-the-air the signal that was modulated by the processing at the step S26 via the antenna 145.

In this way, the intended signal is transmitted from the transmitter 101 to the on-board device 102, which signal corresponds to the user's desired processing, e.g., door locking or unlocking processing or, alternatively, slide door open/close processing.

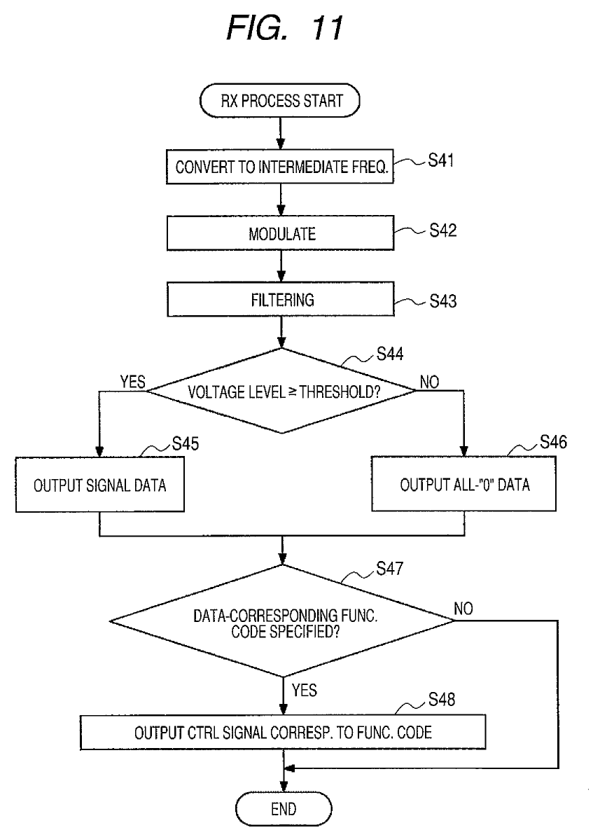

Next, an explanation will be given of a signal reception procedure of the on-board device 102 with reference to a flowchart of FIG. 11. This processing is executed when the signal as sent from the transmitter 101 is received by the antenna 166 of on-board device 102.

At step S41, the signal processor unit 165 converts its received signal into an intermediate frequency (IF) signal by the so-called superheterodyne technique.

At step S42, the demodulator unit 164 performs envelop detection of the resultant signal obtained by the process at step S41, thereby to demodulate it to a baseband signal.

At step S43, the filter unit 163 applies filtering processing to the baseband signal thus obtained by the process of step S42. At this time, the gain of a prespecified frequency signal is reduced in a way corresponding to the filtering characteristics shown in FIG. 7, causing a signal with its frequency higher than the frequency f1 to decrease in gain and experience attenuation when it passes through the filter unit 163. On the contrary, when a signal with its frequency lower than or equal to the frequency f1 passes through the filter unit 163, its gain is kept unchanged so that this signal is not attenuated.

At step S44, the comparator 162 compares to a predefined threshold value the voltage level of the data as supplied from the filter unit 163 through the process at step S43. If the voltage level of such data is higher than or equal to the threshold, then go to step S45 which outputs such data to the control unit 161. If the data voltage level is lower than the threshold then go to step S46 which permits the comparator 162 to output the data to the control unit 161 in the form of an all-zero signal or a null signal.

At step S47, the control unit 161 performs checkup of the ID code and function code being contained in the supplied data as a result of the processing at step S45 or step S46 with the data as prestored in the memory or else to thereby determine whether the function code corresponding to the data supplied from the comparator 162 is specified successfully. At step S47, when the function code contained in the data supplied from the comparator 162 is matched with any one of prestored data items (indicative of a plurality of function codes), it is decided that the function code was specified successfully. If this is the case, the routine goes next to step S48.

At step S48, the control unit 161 executes prespecified control in accordance with the function code that was decided to be specified at step S47.

For example, when the control unit 161 decides that the function code is a binary data “0101” indicating an instruction for car door locking, the on-board device 102 generates at its output a control signal for driving the door lock actuators 121-1 to 121-4. In response to the control signal, the door lock actuators 121-1 to 121-4 are rendered operative to drive the motors to lock the doors.

Alternatively, when it is determined that no function code is specifiable at step S47, the step S48 is skipped.

In this way, the signal reception processing is executed by the on-board device 102. With this procedure configured as described above, it becomes possible to cause the distance capable of enabling the on-board device 102 to operate (i.e., distance between the transmitter 101 and on-board device 102) to become different based on the signal as sent from the transmitter 101 in accordance with the switch that was manually operated by the user in the way stated supra.

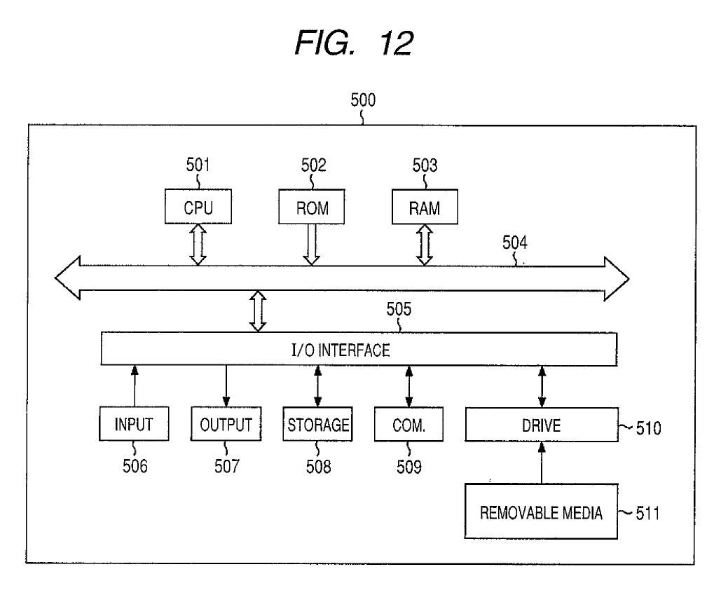

Note that the above-stated sequence of processing tasks is executable either by a hardware configuration or by a software program on a case-by-case basis. In the case of the series of tasks being executed by a software program, this software program is installable, via a network or from recording media, into a computer which is built in an exclusive-use hardware unit or a general-purpose personal computer (PC) 500 shown in FIG. 12, which is able to execute various kinds of functions after installation of various types of application programs.

As shown in FIG. 12, a central processing unit (CPU) 501 executes various kinds of tasks in accordance with a software program which is presently stored in a read-only memory (ROM) 502 or loaded into a random access memory (RAM) 503 from a storage unit 508. The RAM 503 is configured to store therein data needed when the CPU 501 executes various tasks.

The CPU 501, ROM 502 and RAM 503 are connected together via a bus 504. Also connected to this bus 504 is an I/O interface 505.

Several components are connected to the I/O interface 505, including but not limited to an input unit 506, such as a keyboard and/or a pointing device called the “mouse,” a display device including a cathode ray tube (CRT) or a liquid crystal display (LCD) panel, an output unit 507 having one or more audio speakers, a storage unit 508 including a hard disk drive (HDD) or else, and a communication unit 509 including a network interface module, such as a modem or a local area network (LAN) card. The communication unit 509 performs communication processing via networks, including the Internet.

A drive unit 510 is connected to the I/O interface 505, when the need arises. When a removable media 511, such as a magnetic disk, optical disc, magneto-optical (MO) disk or semiconductor memory, is loaded into the drive 510, a computer-executable software program is read out of it for installation into the storage unit 508.

In the case of the above-stated series of processing tasks being executed by a software program, this software program is installed via networks, such as the Internet, or from the removable storage media 511 or other similar suitable storage/record media.

It is noted that the storage media should not exclusively be limited to the removable media 511 such as one or more magnetic disks (Floppy Diskettes™) for storage of programs to be delivered to users in a separate way of the main body of apparatus shown in FIG. 12, optical disks including compact-disc read-only memory (CD-ROM), digital versatile disk (DVD), magnetooptic (MO) disk (e.g., MiniDisc (MD)™), or electrically erasable programmable read-only memory (EEPROM), such as flash memory or else, and may also include any available hardware modules which are configured by the program-storing ROM 502 or HDD included in the storage unit and which are to be delivered to users in the state that these are preinstalled in the main body of apparatus.

Also note that the steps for time-sequential execution of the series of processing tasks as stated in the description are not to be construed as limiting the invention and should be interpreted to include various modifications and alternations, such as a process having steps that are not necessarily performed in the time-sequential manner, e.g., a procedure having steps executable in a parallel way or a routine having steps executed individually.

What is claimed is:

1. A communication system comprising a transmitter capable of being carried by a user and a receiver equipped in a vehicle for receiving a signal as sent from the transmitter and for controlling a plurality of devices also equipped in the vehicle while letting one of them correspond to the signal received, wherein
the transmitter includes:
an operation specifying unit operative to specify that an operation of the user corresponds to which one of operations of the plurality of devices;
a data generation unit for generating an information item corresponding to the specified operation and being selected from a plurality of prestored information items as a digital data at a communication rate being set to any one of at least first and second communication rates of a plurality of communication rates defined correspondingly to the information item;
a modulation unit for modulating a signal of the data generated by the data generation unit; and
a transmission unit for wirelessly sending a signal modulated, and
the receiver includes:
a demodulation unit for receiving the signal sent from the transmitter and for demodulating the signal into the data;
a filter having an attenuation amount defined in a way corresponding to a communication rate of the data demodulated by the demodulation unit, for attenuating data of the second communication rate more significantly than data of the first communication rate;
a comparison unit for comparing a voltage level of the data that passed through the filter with a threshold value; and
a control unit responsive to receipt of data being determined to have a voltage level greater than or equal to the threshold value by comparison of the comparator unit, for outputting a control signal for control of one of the devices equipped in the vehicle.

2. A transmitter for use in a communication system having the transmitter capable of being carried by a user and a receiver equipped in a vehicle for receiving a signal sent from the transmitter and for controlling a plurality of devices also equipped in the vehicle while letting one of them correspond to the signal received, the transmitter comprising:
an operation specifying unit for specifying that an operation of the user corresponds to which one of operations of the plurality of devices;
a data generation unit for generating an information item corresponding to the specified operation and being selected from a plurality of prestored information items as a digital data at a communication rate being set to any one of at least first and second communication rates of a plurality of communication rates defined correspondingly to the information item;
a modulation unit for modulating a signal of the data generated by the data generation unit; and
a transmission unit for wirelessly sending a signal modulated.

3. The transmitter according to claim 2, wherein the data of the first communication rate is for use as data concerning control of door lock of the vehicle whereas the data of the second communication rate is for use as data concerning control of a slide door of the vehicle.

4. A signal transmission method of a transmitter for use in a communication system having the transmitter capable of being carried by a user and a receiver equipped in a vehicle for receiving a signal sent from the transmitter and for controlling a plurality of devices also equipped in the vehicle while letting one of them correspond to the signal received, the method comprising the steps of:
specifying that an operation of the user corresponds to which one of operations of the plurality of devices;
generating an information item being selected from a plurality of prestored information items and corresponding to the specified operation as digital data at a communication rate being set to any one of at least first and second communication rates of a plurality of communication rates defined correspondingly to the information item;
modulating a signal of the data generated; and
wirelessly sending a signal modulated.

5. A receiver for use in a communication system having a transmitter capable of being carried by a user and the receiver being equipped in a vehicle for receiving a signal sent from the transmitter and for controlling a plurality of devices also equipped in the vehicle while letting one of them correspond to the signal received, the receiver comprising:
a demodulation unit for receiving the signal sent from the transmitter and for demodulating the signal into the data;
a filter having an attenuation amount defined in a way corresponding to a communication rate of the data demodulated by the demodulation unit, for attenuating data of the second communication rate more significantly than data of the first communication rate;
a comparison unit for comparing a voltage level of the data that passed through the filter with a threshold value; and
a control unit responsive to receipt of data being determined to have a voltage level greater than or equal to the threshold value by comparison of the comparison unit, for outputting a control signal for control of one of the devices equipped in the vehicle.

6. The receiver according to claim 5, wherein the control unit outputs a control signal relating to door lock control of the vehicle when the data of the first communication rate is supplied thereto and outputs a control signal relating to slide door control of the vehicle when the data of the second communication rate is supplied thereto.

7. A signal receiving method of a receiver for use in a communication system having a transmitter capable of being carried by a user and the receiver being equipped in a vehicle for receiving a signal sent from the transmitter and for controlling a plurality of devices also equipped in the vehicle while letting one of them correspond to the signal received, the method comprising the steps of:
demodulating a signal as sent from the transmitter for demodulating the signal into the data;
causing a filter having its attenuation amount defined by a communication rate of the demodulated data to attenuate data of the second communication rate more significantly than data of the first communication rate;
comparing a voltage level of the data which passed through the filter to a threshold value; and
upon receipt of data having its voltage level as determined by the comparison to be greater than or equal to the threshold value, outputting a control signal for control of one of the devices equipped in the vehicle.
